(19) United States
(12) Patent Application Publication
(10) Pub. No.: US 2008/0287238 A1
(43) Pub. Date: Nov. 20, 2008

(54) TRANSMITTING MULTI-ROW CHAIN

(76) Inventors: Masaru MORIMOTO, Osaka (JP); Atsuhiro TAMIYA, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/046,733

(22) Filed: Mar. 12, 2008

(30) Foreign Application Priority Data
May 16, 2007 (JP) 2007-130918

(51) Int. Cl. F16G 13/02

(52) U.S. Cl. 474/230

(57) ABSTRACT

A transmitting multi-row chain having easy disassembling or assembling such as dismounting or mounting a chain on its sprockets and, when even high load chain tension is applied, the high load is dispersed to each inner plate so that the load balance in the chain width direction is improved. A transmitting multi-row chain in which inner link units each comprising inner plates into which bushes are press-fitted are coupled in parallel with each other through intermediate plates in a width direction of the chain. The coupled inner link units are connected to each other in a large number by connecting pins having a diameter smaller than the diameters of the pin holes of the intermediate plate. The connecting pin is inserted into the pin hole 121 of the intermediate plate whose pitch between pin holes is narrower than the pitch between pin holes of the outer plate, the pin having a medial bend directed toward the pitch zone of the outer link in a state where chain tension is not generated. The bend extends substantially the full width between the outer and intermediate plates when chain tension is generated.

### FIELD OF INVENTION

The present invention relates to a chain for transmitting a large power, and more specifically relates to a transmitting multi-row chain in which inner link units each comprising a pair of right and left inner plates into which a pair of front and rear bushes are press-fitted are coupled together in parallel with each other through intermediate plates in a width direction of the chain and the coupled inner link units are connected to each other in a large number in the longitudinal direction of the chain by a pair of front and rear connecting pins press-fitted into a pair of front and rear pin holes of outer plates disposed on the outermost sides in the width direction of the chain.

### BACKGROUND OF THE INVENTION

In a transmitting mechanism having a large power transmission load a transmitting chain has been used in which a plurality of chain links are disposed in parallel with each other in a width direction of the chain and are integrated by connecting pins.

A conventional strength-enhanced transmitting chain a multi-row chain has been known in which inner link units each comprising a coupled pair of right and left spaced inner plates into which a pair of front and rear bushes are press-fitted are disposed in parallel with each other through a pair of right and left adjacent intermediate plates in a width direction of the chain. The coupled inner link units are connected to each other in a large number in the longitudinal direction of the chain by connecting pins press-fitted into outer plates disposed on the outermost side in the width direction of the chain (see Japanese Laid-Open Patent Publication No. Hei 11-132295, column 4, FIG. 11)

In the above-mentioned conventional multi-row chain, the chain strength is enhanced by press-fitting, so called, close fitting connecting pins into pin holes in the intermediate plates to incorporate them. However, there were problems in that when such a close fit between the intermediate plate and the connecting pin is adopted, the pin hole diameter in the intermediate plate and the pin diameter of the connecting pin must be worked with high precision during manufacturing of the chain. When disassembling or assembling the coupled links, for example when dismounting or mounting a chain on its sprockets, the close fitting operation becomes troublesome and an excessive operational effort is needed.

The problems are illustrated in FIGS. 10, 10A and 10B. Further, to solve the above-described problems, in a case where a connecting pin 540 is incorporated into a pin hole 521 of an intermediate plate 520 by so-called clearance fitting, as shown in FIG. 10, the connecting pin 540 is bent outside the pitch zone of an outer link through an inner link unit 510 when high load chain tension is acted. Thus the chain tension is excessively applied to an inner plate 511a, which is adjacent to an outer plate 530 in a pair of right and left inner plates 511a and 511b forming an inner link unit 510. As the result there was a problem that a load balance in the chain width direction with respect to tension in the longitudinal direction of the chain remarkably becomes worse and the fatigue strength of the chain is reduced.

### SUMMARY OF THE INVENTION

Accordingly, a primary object of the present invention is to solve the above-mentioned prior art problems or to provide a transmitting multi-row chain in which the disassembling or assembling such as dismounting or mounting a chain can be easily achieved. Even if high load chain tension is applied so that a connecting pin is elastically deformed in an outside direction of the pitch zone of the outer link, any high load is dispersed to each inner plate without concentrating the high load to a specified inner plate so that a load balance in the chain width direction is improved.

The present invention solves the above-described problems by providing a transmitting multi-row chain in which inner link units each comprising a pair of right and left inner plates into which a pair of front and rear bushes are press-fitted are coupled in parallel with each other through intermediate plates in a width direction of the chain and said coupled inner link units are connected to each other in a large number in the longitudinal direction of the chain by a pair of front and rear connecting pins press-fitted into a pair of front and rear pin holes of outer plates disposed on the outermost sides in the width direction of the chain. The diameter of said connecting pin is set to be smaller than a diameter of the pin hole of the intermediate plate and is inserted into the pin hole of said intermediate plate. Furthermore, pitch between pin holes of the intermediate plate is set to be narrower than the pin holes of the outer plate. The pin has a medial bend directed toward the pitch zone of the outer link in a state where chain tension is not generated.

The present invention further solves the above-described problems by providing the intermediate plate with annular coined portions formed by coining around pin holes.

The present invention may also include a bearing member, which suppresses sliding contact wear with said connecting pin, press-fitted into the enlarged diameter pin hole of said intermediate plate.

When the two intermediate plates of the coupled links are adjacently disposed in parallel with each other in a width direction of the chain, a single bearing member may be press-fitted into the pin holes of the adjacent two intermediate plates.

It is noted that “a pitch between pin holes” in the transmitting multi-row chain according to the present invention means a maximum distance where inner surfaces of a pair of front and rear pin holes disposed in an intermediate plate or an outer plate are respectively spaced in a longitudinal direction of the chain.

Further, “a pitch zone of an outer link” in the transmitting multi-row chain according to the present invention means a region defined by two virtual lines, which position on the outermost sides in virtual lines connecting inner surfaces of a pair of front and right pin holes positioned in a pair of right and left outer plates.

The illustrated embodiments of the present invention are transmitting multi-row chains in which inner link units each comprising a pair of right and left inner plates into which a pair of front and rear bushes are press-fitted are coupled in parallel with each other through intermediate plates in a width direction of the chain and said coupled inner link units are connected to each other in a large number in the longitudinal direction of the chain by a pair of front and rear connecting pins press-fitted into a pair of front and rear pin holes of outer plates disposed on the outermost sides in the width direction of the chain. Special actions and effects, based on the following special configurations, are exhibited.

Namely, since the diameter of the connecting pin is set to be smaller than the diameter of a pin hole of the intermediate plates, the connecting pin can be loosely fitted with a so-called clearance fit to the intermediate plates during manufacturing the chain. Thus, since this clearance fit does not need machining with high precision, the diameter of the pin hole of the intermediate plates and the diameter of the connecting pin unlike the case of the transmitting multi-row chain of the prior art using a close-fit, the disassembling or assembling, as when disconnecting or connecting a chain, can be easily achieved.

Further, since the connecting pin is inserted into the pin hole of the intermediate plate whose pitch between pin holes is set to be narrower than the outer plate, and has a bend directed toward the pitch zone of the outer link in a state where chain tension is not generated, even if high load chain tension is applied so that a connecting pin is elastically deformed in an outside direction of the pitch zone of the outer link, a high load due to this chain tension is dispersed to each inner plate without concentrating the high load to a specified inner plate. Thus a load balance in the chain width direction is improved and the fatigue strength and tensile strength of the chain can be significantly improved. Additionally, since the bent connecting pin exhibits a spring effect so that impact and vibration acted on the chain can be reliably absorbed, the bending noise liable to occur during a chain operation can be suppressed.

When the intermediate plate has annular coined portions formed by coining around pin holes, in addition to the effect explained above, fatigue strength around a pin hole which may occur when chain tension is applied to the intermediate plate through a connecting pin can be improved. Thus, the life of the chain can be maintained for a long period of time.

When a bearing member, which suppresses sliding contact wear with the connecting pin is press-fitted into a pin hole of the intermediate plate, in addition to the effects explained above, damage of an inner circumferential surface of a pin hole in the intermediate plate due to the sliding contact with the connecting pin is suppressed and the fatigue strength of the intermediate plate with respect to the chain tension is also improved. Thus stable chain traveling can be realized for a long period of time.

When the intermediate plates are adjacently disposed in parallel with each other in plural number in a width direction of the chain, stress load in each plate when the chain tension is applied is reduced. Thus, the fatigue strength of the chain can be improved.

Further, when a single bearing member is press-fitted to pin holes of two adjacent intermediate plates, wear damage of an inner circumferential surface of a pin hole in the intermediate plate due to the sliding contact with the connecting pin is suppressed and the fatigue strength of the intermediate plate with respect to the chain tension is also improved. Thus stable chain traveling can be realized for a long period of time. And since a plurality of intermediate plates can be handled as an integrated body, the disassembling or assembling such as disconnecting or connecting a chain can be easily attained.

### BRIEF DESCRIPTION OF THE DRAWINGS

FIG. 1 is an exploded assembly view of a transmitting multi-row chain, which is one example of the present invention;

FIG. 2 is a plan view showing a partial cross-section of the transmitting multi-row chain of FIG. 1;

FIGS. 3 and 3A are explanatory views exaggeratedly showing the medial bend of the connecting pin of FIG. 2;

FIGS. 4, 4A and 4B are explanatory views showing a tensioned state of the transmitting multi-row chain of FIG. 3 when a tensioning load is applied;

FIGS. 5A and 5B are a plan view and a cross-sectional view showing an intermediate plate with coined portions;

FIG. 6 is an explanatory view of the term “a pitch between pin holes” used in the present application;

FIG. 7 is an explanatory view of the term “a pitch zone of an outer link” used in the present application;

FIG. 8 is a partial cross-sectional view of a transmitting multi-row chain which has bearing members in the intermediate plates;

FIG. 9 is a partial cross-sectional view of a transmitting multi-row chain which has two adjoining intermediate plates and a single bearing member; and

FIGS. 10, 10A and 10B are explanatory views exaggeratedly showing a partial cross-section of a conventional transmitting multi-row chain.

### PREFERRED EMBODIMENTS OF THE INVENTION

In a transmitting multi-row chain in which inner link units each comprising a pair of right and left inner plates into which a pair of front and rear bushes are press-fitted are coupled in parallel with each other through intermediate plates in a width direction of the chain and the coupled inner link units are connected to each other in a large number in the longitudinal direction of the chain by a pair of front and rear connecting pins press-fitted into a pair of front and rear pin holes of outer plates disposed on the outermost sides in the width direction of the chain. The diameter of the connecting pins is set to be smaller than the diameter of the pin hole of the intermediate plate, and the connecting pin is inserted into the pin hole of said intermediate plate. The pitch between pin holes in the intermediate plate is set to be narrower than the pitch in the outer plate. The pin has a bend directed toward the pitch zone of the outer link when chain tension is not generated. The disassembling or assembling of the chain, for example when disconnecting or connecting the chain, is easily achieved and even if high load chain tension is applied so that the connecting pin is elastically deformed outwardly of the pitch zone of the outer link, the high load is dispersed in each inner plate without concentrating the high load to a specified inner plate so that a load balance in the chain width direction is improved.

Although the transmitting multi-row chain of the present invention usually couples two rows or three rows of inner link units in parallel with each other in the chain width direction, more than three rows of the inner link units can, of course, be coupled.

Further, concrete shapes of the inner plate, the outer plate and the intermediate plate used in the present invention may adopt any shapes such as an oval type and a gourd type. Particularly, the intermediate plate may sufficiently have the same or smaller plate width as or than the widths of the inner plate and the outer plate. If the intermediate plates have a plate width smaller than the inner plates and outer plates, when the chain using such intermediate plates is traveled on a chain guide, which sandwiches the chain from both sides, only the height of the inner plates determine the thickness of the conveyor chain and stable traveling can be achieved. Using such a chain configuration can contribute to weight lightening of the entire chain.

Further, as the targets of the transmitting multi-row chains of the present invention either a bush chain or a roller chain may be adapted. However, in a case of the bush chain, the bush chain is the most suitable for a case where it is used during power transmission where power transmission speed is relatively low and the load applied to the chain is small. On the other hand, in a case of the roller chain, since the roller chain has smooth engagement with a sprocket, wear of the chain can be prevented.

The intermediate plate may include an arc-shaped bulged portion, bulged in a direction of plate shearing generated by tension in a longitudinal direction of the chain. The bulged portion may extend beyond a virtual arc line, which defines a peripheral line of a pair of front and rear half arc-shaped plate. Since the arc-shaped bulged portion improves the tensile strength of the intermediate plate in a longitudinal direction of the chain and the elastic modulus to suppress plastic deformation in a direction of an intermediate plate shearing, it increases the strength of the entire chain. Further, since the load balance in a chain width direction with respect to the tension in a longitudinal direction of the chain is improved, even if a large power transmission load is generated, the fatigue resistance of the chain is significantly improved.

A spring washer may be disposed between a pair of right and left intermediate plates loosely surrounding the connecting pin so that the washer applies biasing force right and left toward the pair of right and left outer plates. The spring washer not only prevents backlash, which is liable to occur in an inner plate and an intermediate plate during operation of the chain, but also prevents the position-shift in a chain width direction, liable to occur in the intermediate plate and the inner link unit. The bias phenomenon improves a load balance in the chain width direction with respect to tension in a longitudinal direction of the chain. As the result the fatigue strength and tensile strength of the chain can be improved, and additionally a smooth bending operation of the transmitting multi-row chain is exhibited in engagement with a sprocket during a chain operation so that bending failure and bending noise can be suppressed.

And as concrete embodiments of the rollers incorporated in the transmitting multi-row chain of the present invention, any of a steel roller, a rubber roller, a engineering plastic rollers called as “enpla rollers” and the like may be used. Particularly, in a case of the engineering plastic rollers, since they realize a low noise transfer, they are more preferable.

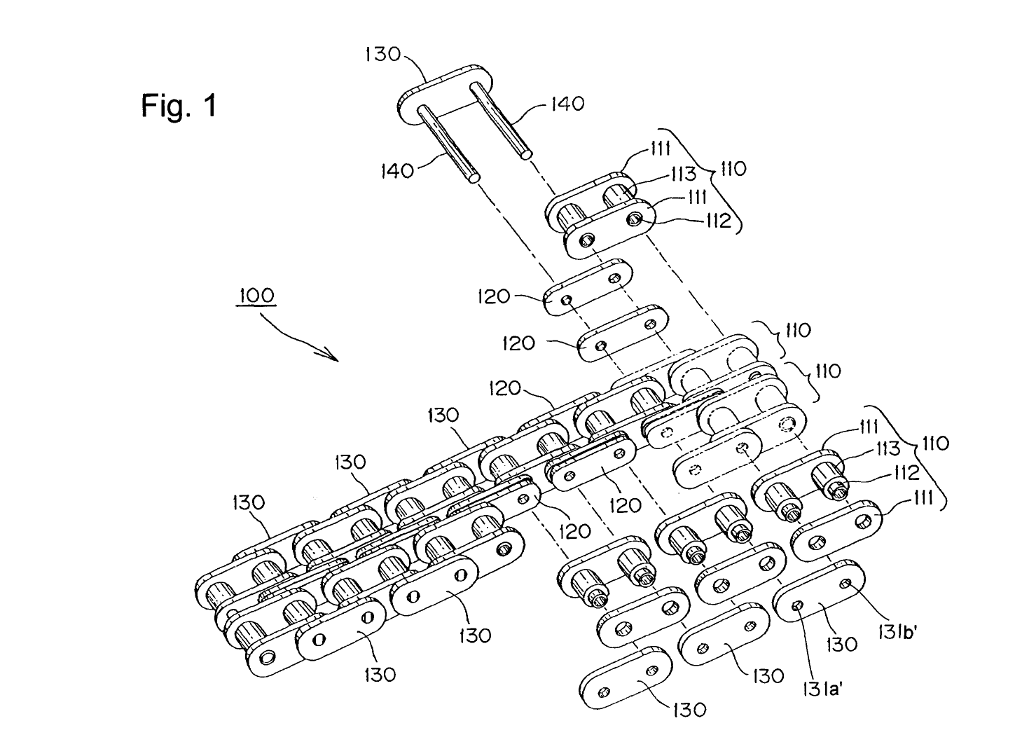

A transmitting multi-row chain 100 that is one example of the present invention will be described based on FIGS. 1 through 7.

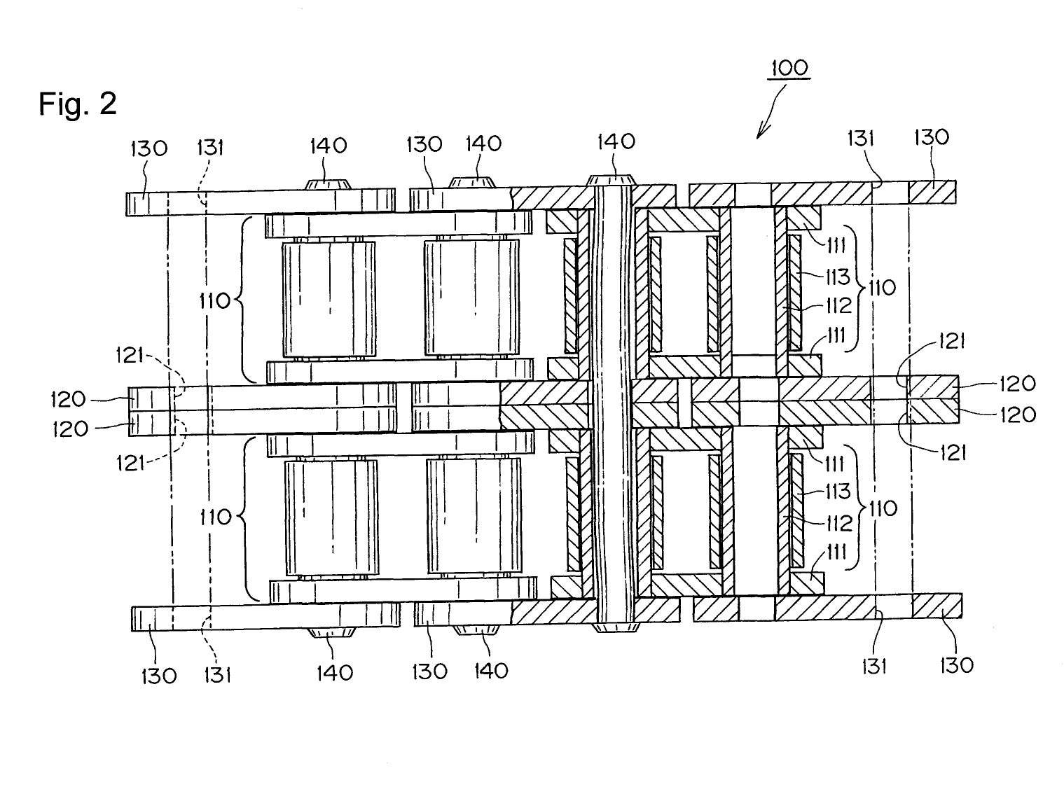

The transmitting multi-row chain 100 is one example of the present invention. As shown in FIGS. 1 and 2, two sets of inner link units each comprising a pair of right and left inner plates 111, 111 into which a pair of front and rear bushes 112, 112 is press-fitted are coupled in parallel with each other through two intermediate plates 120, 120 adjacent in a width direction of the chain. The coupled inner link units 110 are connected to each other in a large number in the longitudinal direction of the chain by a pair of front and rear connecting pins 140, 140 press-fitted into a pair of front and rear pin holes 131a, 131b of the outer plates 130 disposed on the outermost sides in the width direction of the chain. It is noted that the connecting pin 140 is formed in a round type cross-section.

In the transmitting multi-row chain 100, a roller 113 is journaled on the bush 112 of the above-mentioned inner link unit 110 so that the roller 113 is engaged with sprocket teeth while being rolled smoothly during the engagement with a sprocket (not shown). Thus the transmitting multi-row chain 100 forms a roller chain that prevents wear on the chain.

One form of the intermediate plate 120, which is the most characteristic in the transmitting multi-row chain 100 in this example, will be described in more detail with reference to FIGS. 1-7.

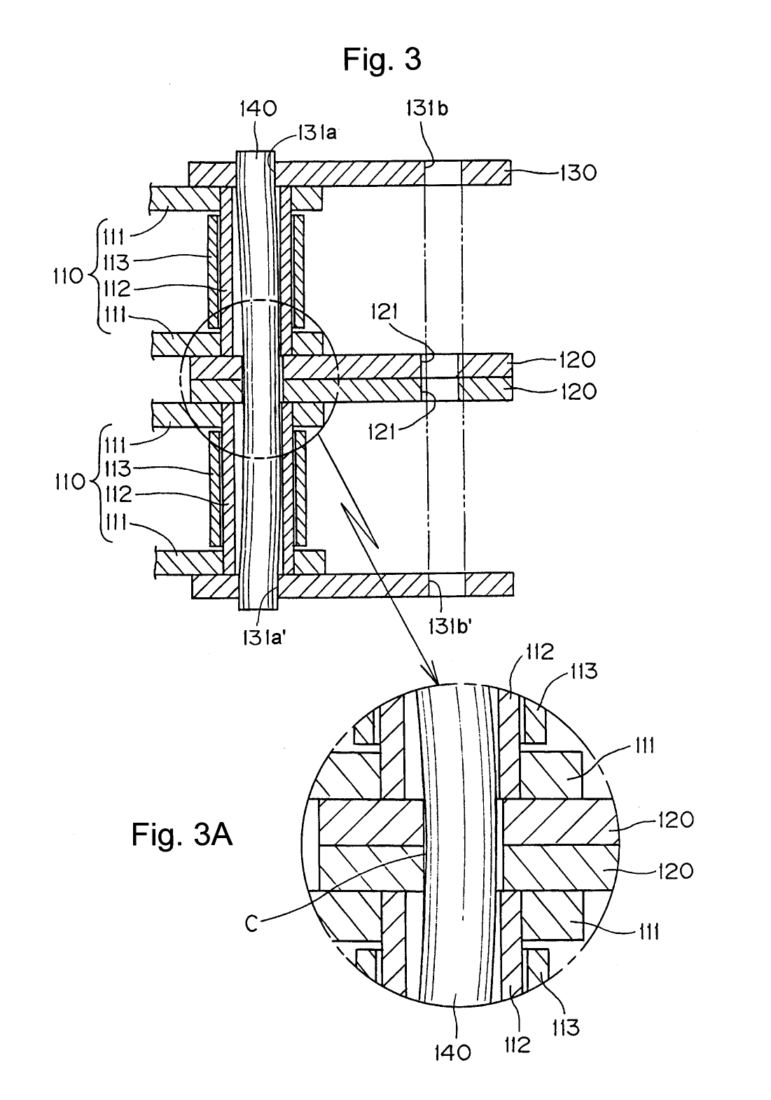

First, as shown in FIGS. 2 and 3, a diameter of the connecting pin 140 is set to be smaller than the diameter of a pin hole 121 of the intermediate plate 120, and the connecting pin 140 can be loosely fitted into the pin hole 121 of the intermediate plate 120, that is a clearance fit may be adopted.

Further, as shown in FIG. 3, a pitch between the pin holes 121 of each intermediate plate 120 is set narrower than a pitch between the pin holes 131 of an outer plate 130, and the connecting pin 140 is inserted into the pin hole 121 of the intermediate plate 121 and has a medial bend directed toward the pitch zone of the outer links in a state where chain tension is not generated. Although not shown in FIG. 3, a connecting pin is press fitted into the other pin holes and has a bend directed toward the pitch zone of the outer links.

It is noted that the reference character C in FIG. 3A identifies clearance between the medial bend of the connecting pin 140 and the inner circumferential surface of the pin hole 121 of the intermediate plate 120.

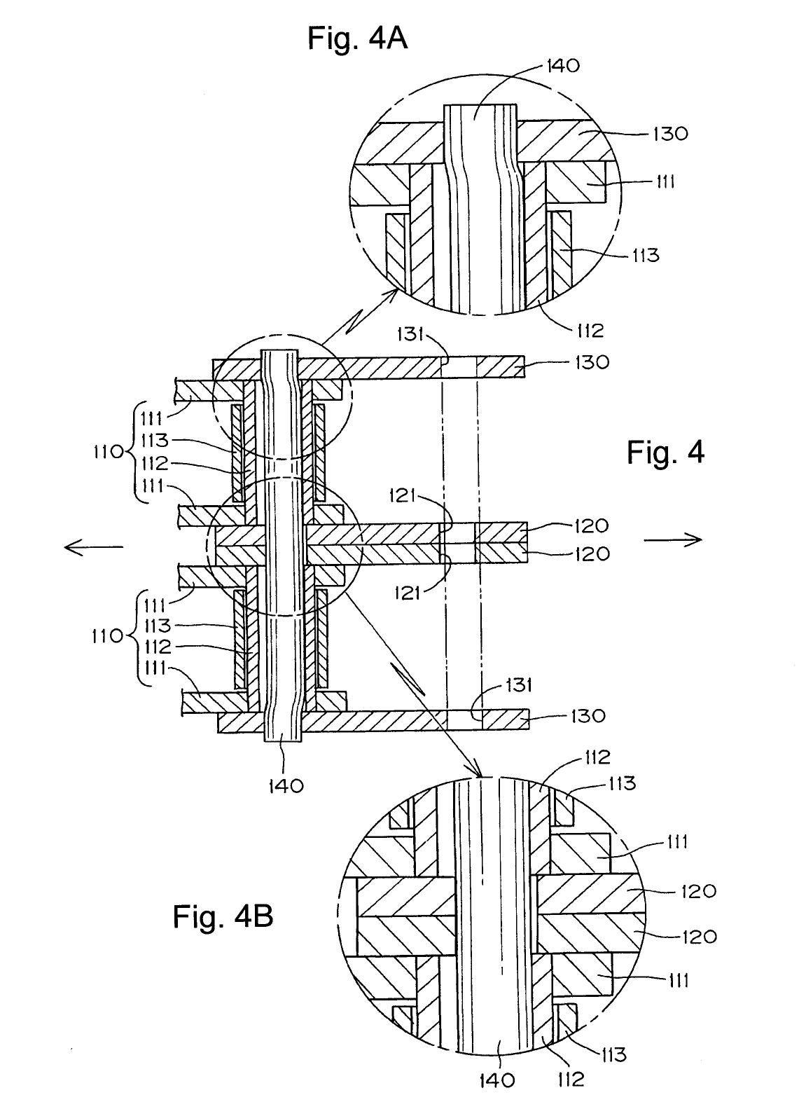

As shown in FIGS. 4-4B, when high load chain tension is applied, the connecting pin 140 is elastically deformed in the above-mentioned clearance C in a direction toward the outside of the pitch zone of the outer link, so that the medial bend extends substantially the full width between the pin holes 131a or 131b of the outer plates 130. As a result, the connecting pin 140 abuts the inner circumferential surfaces of bushes 112 along the entire chain width so that high load due to the chain tension is substantially equally dispersed with respect to four inner plates 111, 111, 111, 111.

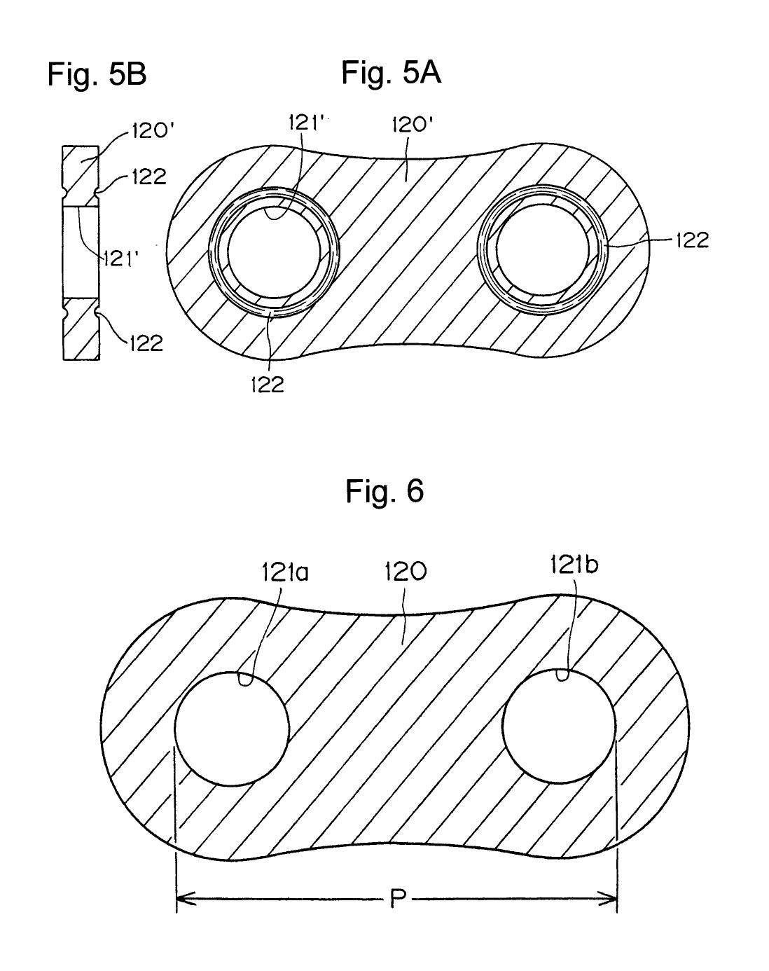

As shown in FIGS. 5A and 5B, a modified link 120′ has an annular coined portion 122 formed by coining provided around the pin hole 121′ of the intermediate plate 120′, and this coined portion 122 is increased in its strength more than other plate portions.

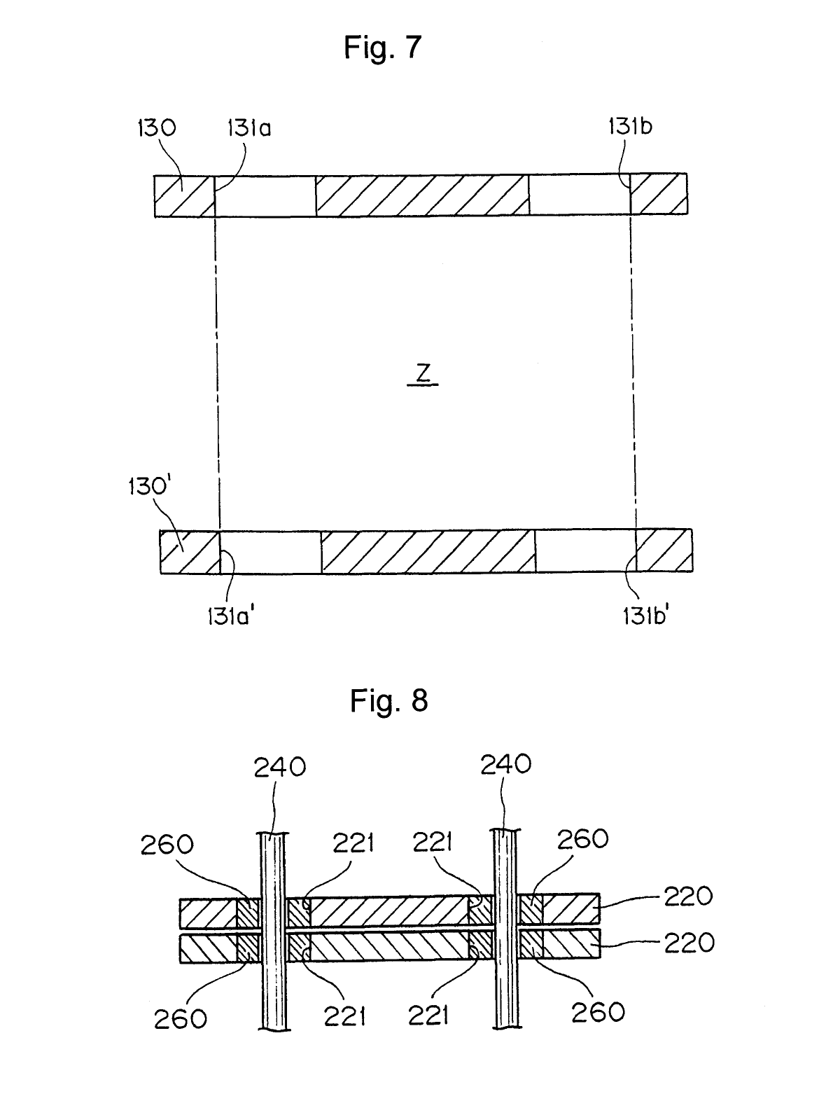

It is noted that “a pitch P between pin holes” in the transmitting multi-row chain according to the present invention means, as shown in FIG. 6, a maximum distance where inner surfaces of a pair of front and rear pin holes 121a and 121b disposed in an intermediate plate 120 are respectively spaced in a longitudinal direction of the chain. The “pitch” also means the maximum distance between the pin holes 131a and 131b in the outer plate 130, as seen in FIG. 7,

Further, “a pitch zone Z of an outer link” in the transmitting multi-row chain according to the present invention means, as shown in FIG. 7, a region defined by two virtual lines positioned on the outermost sides of the pin holes and extending between the inner confronting surfaces of the pair of front and right pin holes 131a, 131b, 131a′, 131b′ in the pair of right and left outer plates 130, 130′.

In the embodiments of FIGS. 1-7, the diameter of the connecting pin 140 is smaller than a diameter of the pin hole 121 of the intermediate plate 120 and the connecting pin 140 can be loosely fitted with a clearance fit in the pin hole 121 of the intermediate plate 120 during manufacturing the chain. Since this clearance fit does not need high-precision machining, the diameter of the pin hole 121 of the intermediate plate 120 and the diameter of the connecting pin 140, unlike the case of the transmitting multi-row chain using close-fitting. The loose fits enables easy disassembling or assembling, for example when dismounting or mounting the chain on its sprockets.

The connecting pin 140 is inserted into the pin hole 121 of the intermediate plate 120 whose pitch between pin holes is set to be narrower than the outer plate 130, and has a medial bend in the pin hole 121 directed toward the pitch zone of the outer link in a state where chain tension is not applied, as shown in FIG. 3. When tension is applied, the pin is elastically deformed to extend substantially the full width between the plates 130, as shown in FIGS. 4-4B.

Even if high load chain tension is applied so that a connecting pin 140 is elastically deformed in an outside direction of the pitch zone of the outer link, the high load due to this chain tension is substantially equally dispersed to each inner plate 111, 111, 111, 111 without concentrating the high load to a specified inner plate 111. Thus a load balance in the chain width direction is improved and the fatigue strength and tensile strength of the chain can be significantly improved. The bend of the connecting pin 140 exhibits a spring effect so that impact and vibration acted on the chain can be reliably absorbed, and the bending noise liable to occur during a chain operation can be suppressed.

When the intermediate plate 120′ has annular coined portions 122 formed by coining around the pin holes 121′, fatigue around the pin hole 121′ which is liable to occur when chain tension is applied to the intermediate plate 120′ through the connecting pin, can be reduced and the life of the chain can be maintained for a long period of time.

Since two intermediate plates 120, 120 are coupled in parallel with each other in plural number in a width direction of the chain, the stress load in each plate when chain tension is applied is reduced and the fatigue strength of the chain can be improved.

A further embodiment of the transmitting multi-row chain according to the present invention is shown in FIG. 8. Since the components other than the intermediate plate 220 and the bearing member 260 in the transmitting multi-row chain 200 are just the same as the above-described transmitting multi-row chain 100, the descriptions relating to the transmitting multi-row chain 100 except for the configurations of the intermediate plate 220 and the bearing member 260 will omitted by changing reference characters 100 to 140 of FIGS. 1 to 7 to reference characters 200 to 240 in FIG. 8.

When the coupled link units provide a clearance space, as shown between the plates 220 in FIG. 8, spring washers may be disposed in the clearance spaces loosely surrounding the connecting pins so that the washers apply equal biasing forces right and left toward the plates 220. The washers may be inserted, whether or not the chain includes the bearing members 260.

As shown in FIG. 8, four bearing members 260, 260, 260, 260, which suppress the sliding contact wear with the connecting pins 240, are respectively press-fitted into pairs of front and rear pin holes 221, 221, 221, 221 of two intermediate plates 220, 220.

Since wear damage to the inner circumferential surfaces of pin holes 221 in the intermediate plates 220 due to the sliding contact with the connecting pin 240 is suppressed and the fatigue strength of the intermediate plate 220 with respect to the chain tension is also improved, stable chain traveling can be realized for a long period of time.

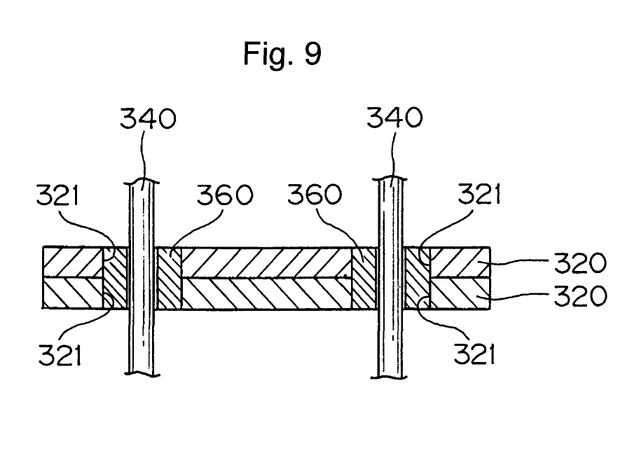

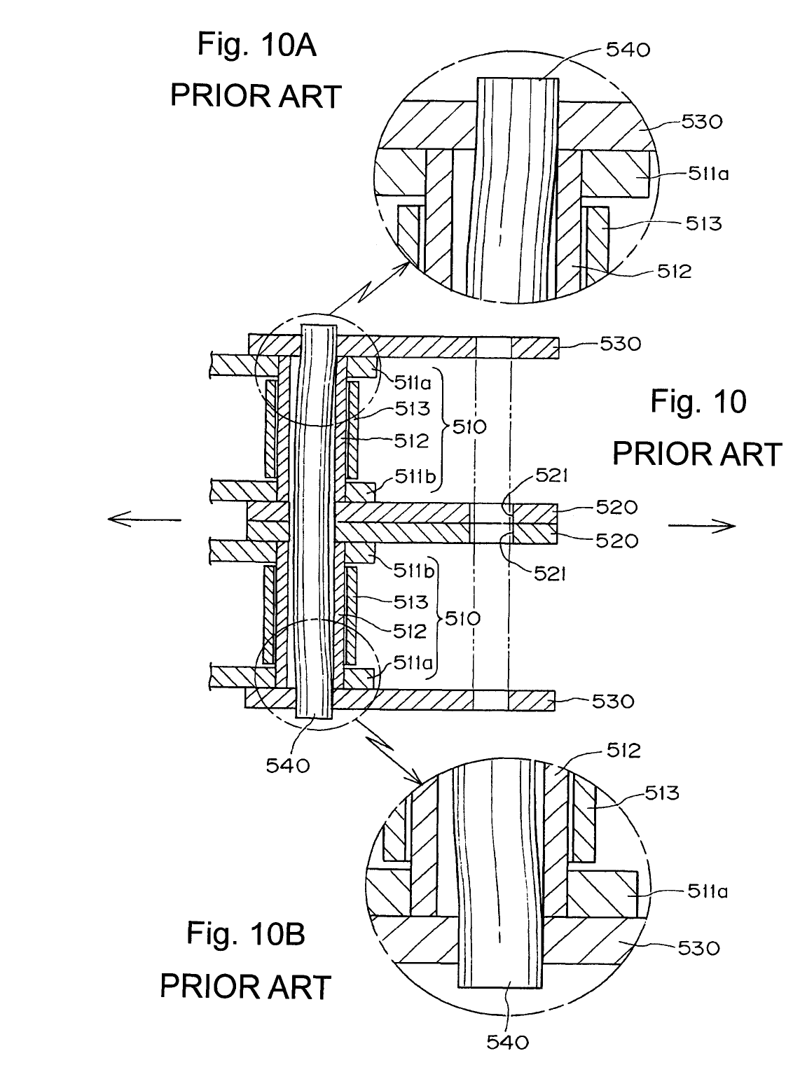

Another embodiment of the transmitting multi-row chain according to the present invention is shown in FIG. 9. Since the components other than the intermediate plate 320 and the bearing member 360 in the transmitting multi-row chain 300 are the same as the above-described transmitting multi-row chain 100, the descriptions relating to the transmitting multi-row chain 100 except for the configurations of the intermediate plate 320 and the bearing member 360 will omitted by changing reference characters 100 to 140 shown in FIGS. 1 to 7 to reference characters 300 to 340 in FIG. 9.

As shown in FIG. 9, single bearing members 360, which suppress the sliding contact wear with the connecting pins 340, are respectively press-fitted into opposed pin holes 321, 321 of two intermediate plates 320, 320 of the coupled link units.

Since wear damage of inner circumferential surfaces of pin holes 321, 321 in the intermediate plates 320, 320 due to the sliding contact with the connecting pin 340 is suppressed and the fatigue strength of the intermediate plate 320 with respect to the chain tension is also improved. Stable chain traveling can be realized for a long period of time. And since two intermediate plates 320, 320 can be handled as an integrated body, the disassembling or assembling such as disconnecting or connecting a chain can be easily achieved. Thus, the advantageous effects of the present invention are very large.

1. A transmitting multi-row chain comprising a large number of inner link units,
each of said units comprising right and left inner plates, and front and rear bushes disposed in parallel with each other, said bushes being press fitted into said right and left inner plates,
said units being coupled in a width direction of the chain, in groups between two outer plates having front and rear outer pin holes through two intermediate plates having front and rear intermediate pin holes
front and rear connecting pins passing through said bushes and said intermediate pin holes, said connecting pins being press fitted into said front and rear outer pin holes to connect said coupled inner link units to adjoining coupled inner link units in a large number in the longitudinal direction of the chain, wherein
the diameter of said connecting pins is smaller than the diameter of the intermediate pin holes of said intermediate plate, and
the pitch between said intermediate pinholes defining an intermediate pitch zone and the pitch between said outer pin holes defining an outer pitch zone, said pitch between said inner pin holes on the inner plate being narrower than the pitch between said outer pin holes of the outer plate, and
at least one of said connecting pins which is press fitted into said rear outer pin holes having a medial bend directed toward the pitch zone of said outer links in a state where chain tension is not generated.

2. A transmitting multi-row chain according to claim 1, wherein another one of said connecting pins which is press-fitted into said front outer pin holes has a medial bend directed toward the pitch zone of said outer links in a state where chain tension is not generated.

3. A transmitting multi-row chain according to claim 1, wherein said intermediate plate has annular coined portions around said intermediate pin holes.

4. A transmitting multi-row chain according to claim 1, including a bearing member, which suppresses sliding contact wear with said connecting pin, press-fitted into each of said intermediate pin holes of said intermediate plate.

5. A transmitting multi-row chain according to claim 1, wherein said intermediate plates of said coupled link units are adjacently disposed in parallel with each other, and including a single bearing member, which suppresses sliding contact wear with said connecting pin, press-fitted to pin holes of said adjacently disposed intermediate plates.

6. A transmitting multi-row chain according to claim 1, wherein said chain is subject to generation of tension, said medial bend of the pin, when the chain is tensioned, extending substantially the full width between said outer and intermediate plates when said chain is tensioned.
